(19) United States
(12) Patent Application Publication
(10) Pub. No.: US 2017/0287196 A1
(43) Pub. Date: Oct. 5, 2017

(54) GENERATING PHOTOREALISTIC SKY IN COMPUTER GENERATED ANIMATION

(71) Applicant: Microsoft Technology Licensing, LLC, Redmond, WA (US)

(72) Inventors: Gavin Raeburn, Leamington Spa (GB); James Alexander Wood, Leamington Spa (GB); Scott Crawford Stephen, Bishops Itchington (GB); Kelvin Neil Janson, Nottingham (GB)

(21) Appl. No.: 15/088,470

(22) Filed: Apr. 1, 2016

(51) Int. Cl. G06T 13/80; A63F 13/25; H04N 5/247; G06T 11/00; G06T 1/00

(52) U.S. Cl. CPC G06T 13/80; G06T 11/001; G06T 1/0007; H04N 5/247; A63F 13/25; G06T 2210/61

(57) ABSTRACT

Realistic sky simulations are created in a computer generated graphics environment by incorporating captured image data of real sky over a time period, and converting these images into a streams of textures over time which can be sampled as a function of space and time within a game engine. The captured image data include data captured from a light probe indicating intensity and direction of light and a presumed direction of the sun. To capture such image data, an image capture rig comprising multiple cameras and a light probe is used. The image data captured from such cameras over a time period are processed to generate data used by an animation engine to produce photorealistic images of the sky.

### BACKGROUND

In interactive, computer-generated animation, such as in a video game, the animation may include not only simulated images of objects, such as characters, vehicles, tools and landscape, but also can include a simulated sky. While the sky can appear realistic, it is difficult to generate an image of the sky that is realistic across a time frame which the animation is intended to represent. Video games that are called “open world” games typically have a sky component in their animation, and a dynamic time of day.

For example, a video game may include a car race intended to take place, as a simulated environment, over several hours. If the sky does not change, for example, if the sun does not move or if the lighting otherwise remains the same, then the simulation of passage of time does not appear realistic to an end user. Also, lighting of objects in a scene can be affected by clouds, in terms of both light intensity and location of shadows, and time of day. The failure to properly account for clouds and light intensity also impacts perceived realism of the animation.

Because of these challenges, some computer games use static sky images and static lighting, which requires the apparent time of day in the animation to remain static. As an alternative, some computer games do not provide realistic animation, and thus can also provide a simplistic, nonrealistic graphic representation of the sky. As another alternative, some computer games are based on artist-created animation, in which an animator creates a scene with lighting, cloud objects and the like. Such animation techniques are laborious, requiring tedious refinement.

### SUMMARY

This Summary introduces a selection of concepts in a simplified form, which are further described below in the Detailed Description. This Summary is intended neither to identify key or essential features, nor to limit the scope, of the claimed subject matter.

Realistic sky simulations are created in a computer generated graphics environment by incorporating captured image data of real sky over a time period, and converting these images into a streams of textures over time which can be sampled as a function of space and time within an animated sequence, such as generated by a game engine. The images of the real sky can be captured at a location corresponding to a simulated location which the animation is attempting to recreate. The captured image data include an image a light probe placed in the field of view of a camera. From the image of the light probe, data indicating intensity and direction of light and a presumed direction of the sun can be determined. To capture such image data, an image capture rig comprising multiple cameras and a light probe is used. The image data captured from such cameras over a time period are processed to generate data used by an animation engine to produce photorealistic images of the sky.

By accessing high dynamic range images of sky data sampled over a period of time from images of actual sky, photorealistic sky textures can be generated and applied to a scene in computer animation, in particular in a real-time dynamic environment such as a computer game. From some sky data, diffuse cube maps also can be generated. Such diffuse cube maps can be used to provide lighting for the scene. The sky data also can be processed to provide fog cube maps and cloud shadow maps. By accessing cloud shadow maps, realistic shadows can be generated on the scene.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a data flow diagram of an example implementation of a camera system and a computer system that generates photorealistic sky animation.

FIG. 2 is a top view of an example implementation of a camera rig.

FIG. 3 is a side view of an example implementation of a camera rig.

FIG. 4 is a block diagram of an example implementation of equipment for controlling a camera rig.

FIG. 5 is a flow chart of an example implementation of a process for capturing images using a camera rig.

FIG. 6 is a flow chart of an example implementation of a process for processing image captured from a camera rig to generate sky textures.

FIG. 7 is a flow chart of an example implementation of a process for processing images captured from a camera rig to generate additional information.

FIGS. 8A and 8B are data flow diagrams of an illustrative example implementation of a game engine.

FIG. 9 is a flow chart describing an example implementation of rendering scenes with photorealistic sky in an animation.

FIG. 10 is an illustrative example of a shader tree for rendering a scene.

FIG. 11 is block diagram for an example implementation of a general purpose computer.

### DETAILED DESCRIPTION

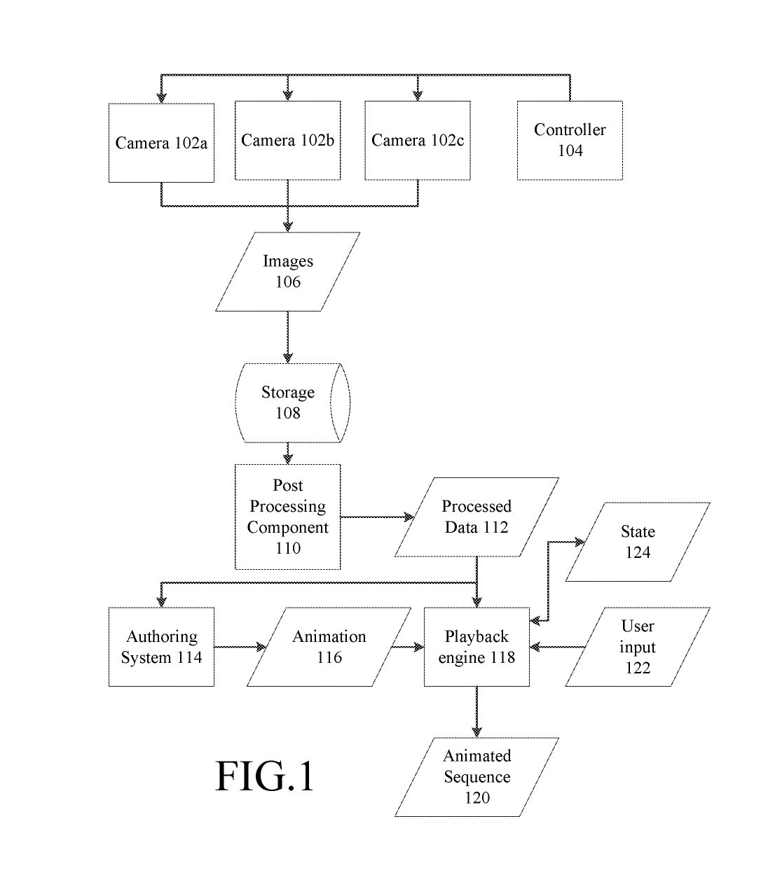

Referring to FIG. 1, an example implementation of a camera system and a computer system that generates photorealistic sky animation will now be described. FIG. 1 is intended to illustrate data flow among components of such a system. In such data flow diagrams herein, data is represented by non-rectangular parallelograms in the drawings. Processing components have inputs to receive data, perform operations on data, and have outputs to provide data, are represented by rectangles in the drawings.

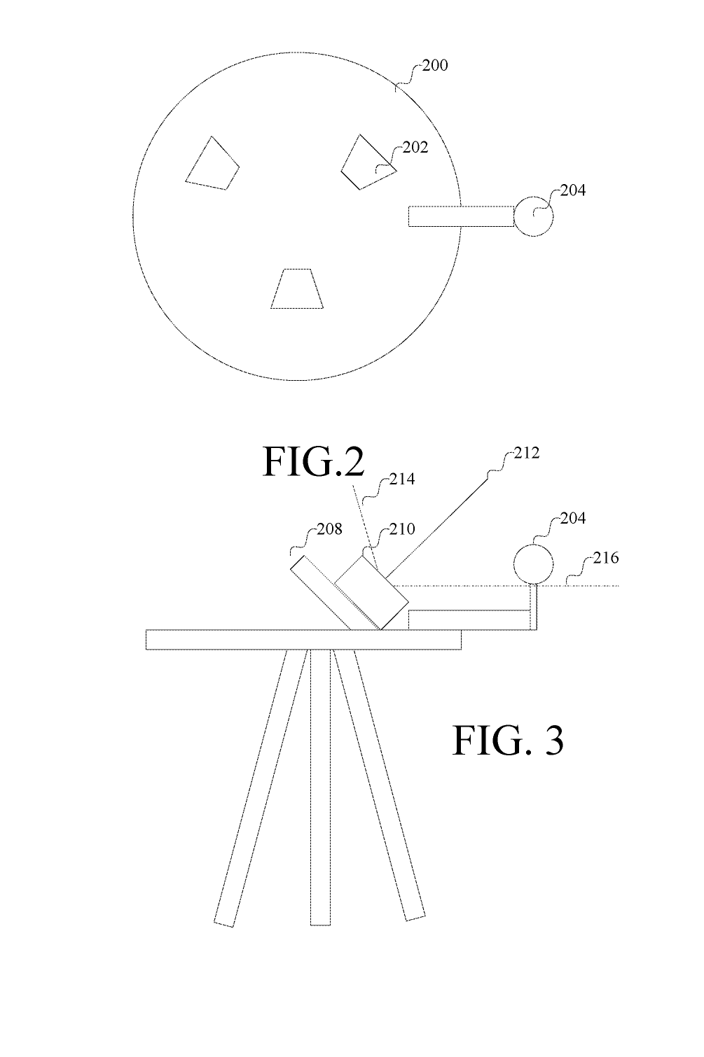

In FIG. 1, a camera rig 100 includes multiple cameras, in this example three cameras 102a, 102b, 102c, which are arranged to capture image data of the sky. More details of an example construction of such a camera rig are described below in connection with FIGS. 2 and 3. Each of the cameras in the camera rig is controlled by a controller 104 to produce a stream of time-lapse images. When the camera rig is appropriately placed in an environment and directed to the sky, the streams of time-lapse images from the cameras provide captured images 106 of the sky. The captured images 106 are stored in storage 108. In one example implementation described below, each camera 102a, 102b, 102c, has internal, removable storage, such as a memory card, on which the captured images 106 are stored. In another example implementation, each camera can output image data as it is captured to one or more external storage devices or one or more computers that in turn store data on a storage device. Stored data can be further transferred to yet other storage devices to be processed by computers.

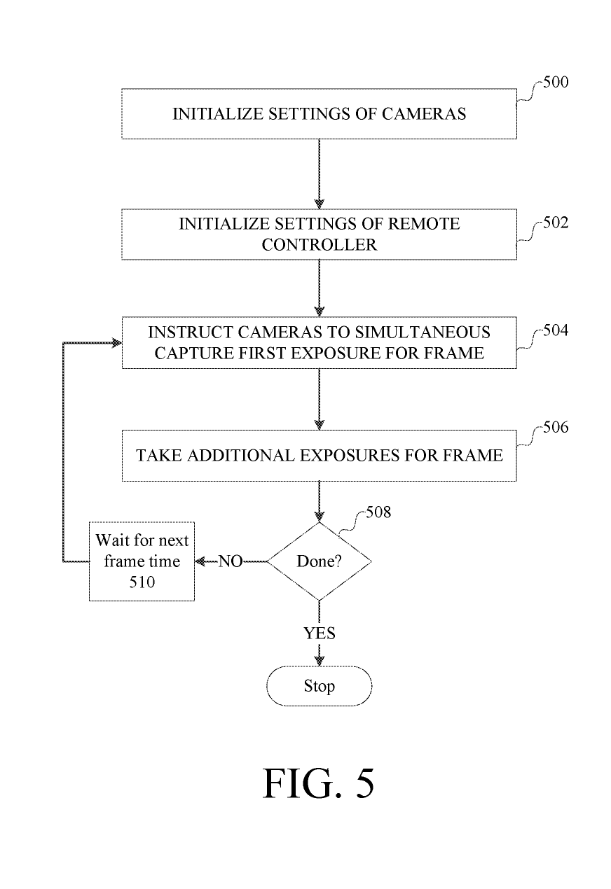

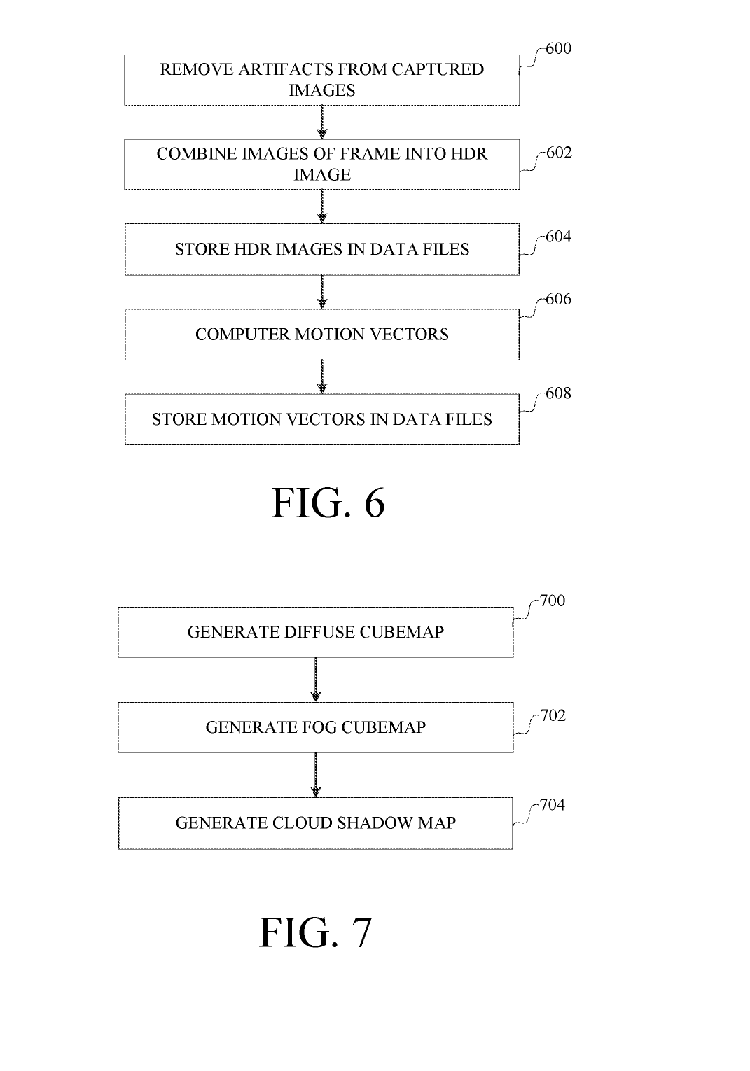

In particular, after captured images 106 from a period of time have been stored, these images can be processed by a computer for use in a computer-based animation system. A post-processing component 110 is a computer that runs one or more computer programs that configure that computer to process the captured images 106 and generate different forms of processed data 112 for use in computer-based animation. More than one computer can be used as a post-processing component 110. A computer that can be used to implement the post-processing component is described in more detail below in connection with FIG. 5. More details about the processed data 112 and how they are generated are described below in more detail in connection with FIGS. 6-11.

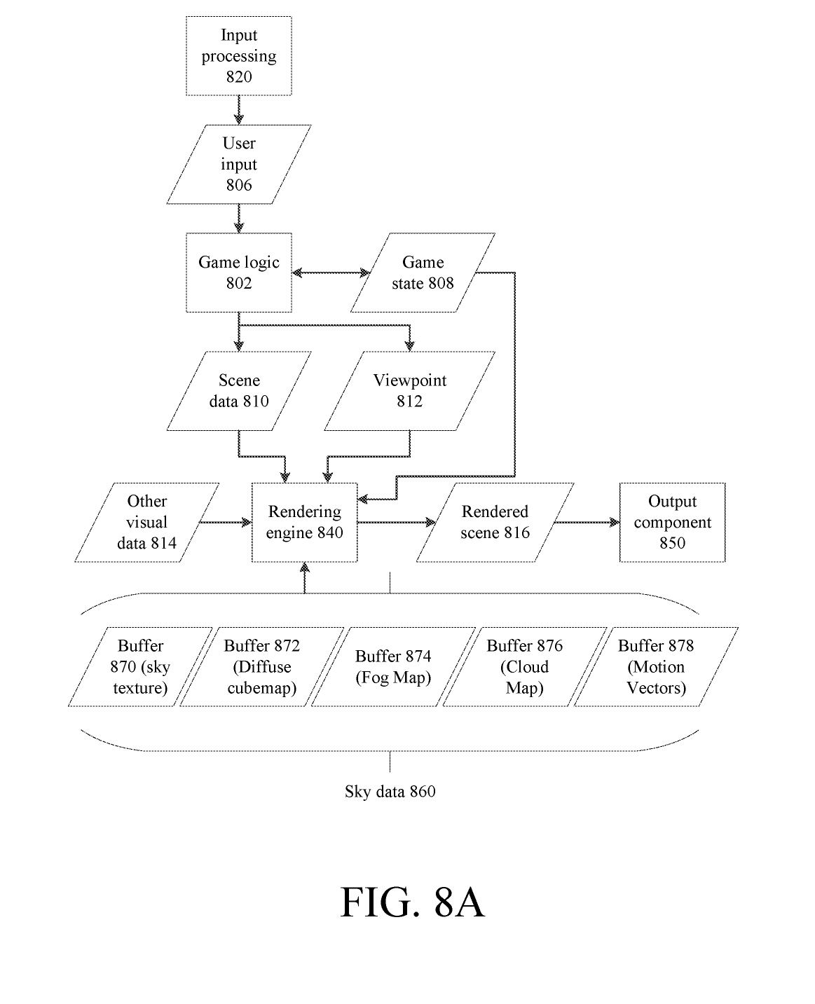

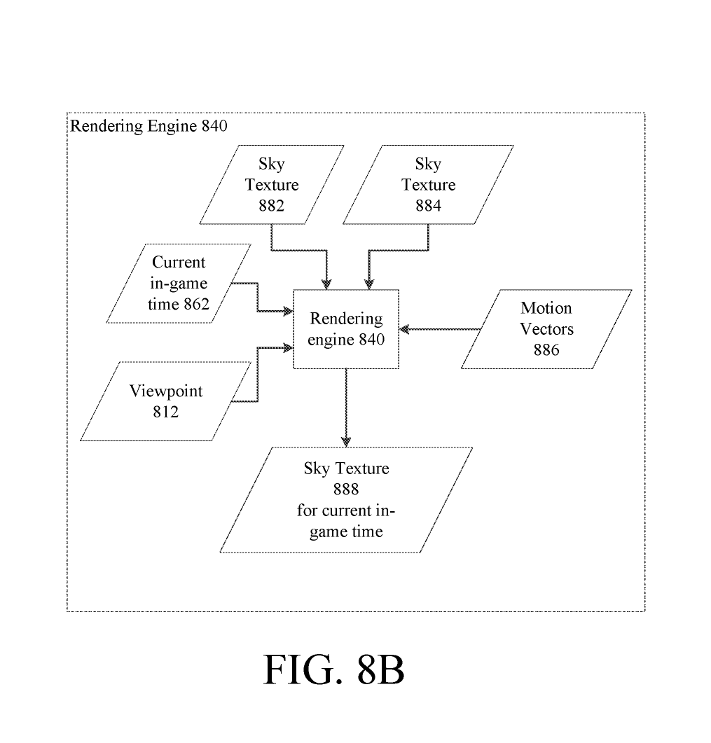

The processed data 112 are used in two aspects of computer animation. The processed data are used by an authoring system 114 to allow animators to create animation 116 using the processed data. The animation 116 generally includes data, including at least a portion of the processed data 112, used by a playback engine 118 to generate display data including a photorealistic animation. In some instances, such animation is an interactive multimedia experience, such as a video game. The authoring system is a computer that runs a computer program that facilitates authoring of computer-based animation, such as an interactive animation such as a video game. Such a computer generally has an architecture such as describe in connection with FIG. 12. Examples of game authoring systems include but are not limited to the UNREAL game engine from Epic Games, Inc., of Cary, N.C., and the FROSTBITE game engine from Frostbite of Stockholm, Sweden. Such a game engine can be augmented with additional software, such as for controlling effects. An example of such software is the FXStudio effects controller available from AristenFX. Such a game engine can be modified as describe herein to provide for an animated sky in a game title generated using the game engine. An example implementation of the authoring system is described in more detail below in connection with FIG. 8-11.

For interactive animation, a playback engine 118 receives the created animation 116, which incorporates at least a portion of the processed data 112, and generates photorealistic animations 120. The playback engine 118 generates the animation 120 in response to user inputs 122, from various input devices, based on the state 124 of the interactive animation, such as a current game state. For example, the current game state will include a current point of view, typically of the user, that is used to generate a view of a scene from a particular vantage point (position and orientation in three-dimensions) within the scene, and a measure of time, such as a simulated time-of-day. The game state 124 is dependent at least on the user input and machine inputs, such as time data to provide for the progression of time in the game.

A playback engine is a computer that runs a computer program that generates the animation, such as a game. Such a computer generally has an architecture such as describe in connection with FIG. 12. Example computers include game consoles, such as an XBOX-brand game console from Microsoft Corporation, desktop computers and even mobile phones that include computer processing sufficient to run computer games.

Turning now to FIGS. 2-5, an example implementation of a camera rig will now be described in more detail. FIG. 2 illustrates a top plan view; FIG. 3 illustrates a side view.

This example camera rig includes a rigid platform 200, which can be made of, for example, wood, metal or other rigid material. Three cameras 202 are attached to the platform 200 in a fixed spatial relationship with each other. As shown in this top view, three cameras 202 are generally arranged within a plane defined by the platform 200 in an approximate equilateral triangle. The cameras can be attached in a manner that allows them to be removed and for their relative positions to be adjusted; however, during a period of time in which images are being captured the cameras remain in a fixed position.

Three cameras are used because, generally speaking, two cameras do not have sufficient field of view the capture the whole sky. While four cameras can be used, any increase in the number of cameras used also similarly increases the amount of image data captured and increases complexity of post-processing. Generally speaking, a plurality of cameras is used and they are positioned so as to have slightly overlapping fields of view to allow images captured by the cameras to be stitched together computationally.

An example commercially available camera that can be used is a digital single lens reflex (DSLR) camera, such as a Canon EOS-1D-X line of cameras. Factors to consider in selection of a camera are speed at which images of multiple different exposure times can be taken and an amount of storage for images. The images at different exposure times should be taken as close together in time as possible to avoid blurriness in the resulting HDR image. With such a camera, an external battery can be used which can power the camera for a full day (i.e., 24 hours). Additionally, large capacity memory cards are available, and in some cameras, two memory cards can be used. Current commercially available memory cards store about 256 gigabytes (Gb).

With such a camera, a diagonal fish-eye lens is used to capture a landscape style image. As described in more detail below, the cameras are arranged so that the bottom of the field of view of the lens is aligned approximately with the horizon. An example of a commercially available lens that can be used is a Sigma-brand 10 millimeter (mm) EX DC f/2.8 HSM diagonal fish-eye lens.

The camera rig also can include a light probe 204, which is a sphere-shaped object of which images are taken to obtain a light reference. The light probe is mounted on a support, such as a narrow rod, so as to be captured in the field of view of one of the cameras. The object may be mirrored or grey. Alternatively a 180-degree fish eye lens can be used. While a light probe can be omitted, images from a light probe can be used in an animation for tuning an animated sun or other light source. The images captured of the light probe provide a reference point over time. Without the light probe, more guess work may be required to determine whether clouds are visible and what the intensity of the sun is at a given point in time. The light probe is attached to the platform. When the camera rig is positioned for use, the light probe is positioned to face directly to true north, if in the northern hemisphere, or directly to true south, if in the southern hemisphere.

In the side view of this example camera rig as shown in FIG. 3, a tripod 206, or other form of support, can be used to provide a stable base to support the platform. By using a tripod with legs that have adjustable length, the leg length can be adjusted so that the platform is level.

FIG. 3 also illustrates more detail of the orientation of the cameras as mounted on the platform, but illustrates one of such cameras. Each camera has a body 210 that is mounted on a mounting device 208 so that an optical axis 212 of a lens of the camera is at an angle β with respect to the platform 200. Mounting the camera at this angle directs the line of sight from the camera up towards the sky, assuming the platform is level. The mounting device 208 can have an angular adjustment with respect to the platform to define an angle α of the mounting device with respect to the platform, where β=90°−α. Generally, β is dependent on the field of view of the lenses used for the cameras. In any given shoot, the angle β should be the same for all cameras and can be fixed in place for the shoot. With a plurality of cameras mounted on the platform, the cameras are positioned at an angle β so that the tops of the fields of view of the cameras, as indicated at 214, are as close to overlapping of possible, if not slightly overlapping, and the bottoms of the fields of view as indicated at 216 are approximately aligned with a horizon. The angle can be determined analytically based on properties of the lens, but also can be evaluated experimentally through images taken by the camera. By overlapping the fields of view of the cameras, images captured by the cameras can be stitched together computationally more easily.

The cameras also can be configured with lens heaters to keep the lenses warm and reduce the likelihood of dew or condensation building up on the lenses. The cameras also typically have filters which may be changed during a period of time in which images are captured. As an example, the cameras can have rear-mounted gel filters housed in filter cards. Such filters generally include filters optimized for capturing day images, and filters optimized for capturing night images. In a 24-hour period of capturing images, such filters may be changed twice a day, to switch between the day filters and the night filters.

Each of the cameras 202 has an interface (not shown) to which a computer can be connected to provide for computer control of the operation of the cameras. Cabling from the cameras can be directed to one or more weather-resistant containers which house any electronic equipment used for controlling the cameras and for capturing and storing image data.

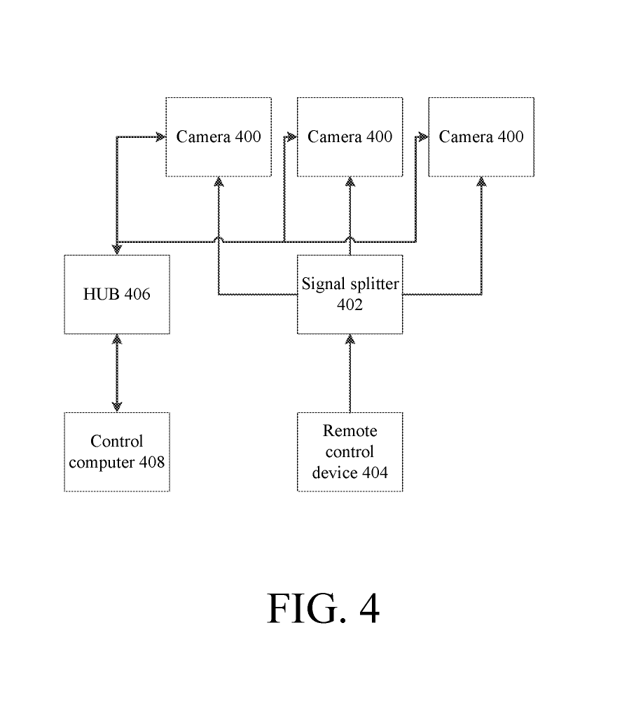

FIG. 4 illustrates an example implementation of a configuration of electronic equipment for controlling the cameras.

The cameras 400 are connected through a signal splitter 402 to a remote control device 404. The remote control device manages the timing of exposures taken by the cameras. An example of a commercially available remote control that can be used is a PROMOTE CONTROL remote controller available from Promote Systems, Inc., of Houston, Tex.

Also, the cameras each have a computer serial interface, such as a universal serial bus (USB) interface. Using a USB compliant cable, the cameras are connected from these interfaces to a hub 406, such as a conventional USB hub, which in turn is connected to a control computer 408. The control computer runs remote control software that configures the control computer to acts as a controller for managing settings of the cameras through the USB interfaces. An example of commercially available remote control software for the control computer that can control multiple DSLR cameras and can run on a tablet, notebook, laptop or desktop computer is the DSLR Remote Pro Multi-camera software available from Breeze Systems, Ltd., of Surrey, United Kingdom.

Given such a configuration, an example image capture process for a twenty-four hour period of capturing images, will now be described in connection with FIG. 5.

The location selected for capturing the images of real sky is preferably one that corresponds to a simulated location which an animation is attempting to recreate. As a result, for example, night sky images in particular will be more realistic. Such co-location of the data capture and the simulated location in the animation is not required, and the invention is not limited thereto.

After setting up the camera rig so that the platform is level, the cameras are in a fixed spatial relationship and the light probe is directed north or south, as the case may be, the settings for the camera can be initialized 500 through the control computer 408. The settings for the remote control 404 for the exposures also can be initialized 502. The remote control settings define a sequence of exposures to be taken and a timing for those exposures.

As one example implementation, the cameras are configured so that they each take a shot at the same time. Generally a set of shots are taken at different exposure times by each camera at each frame time, and each frame time occurs at a set frame rate. In one particular implementation, the frame rate is a frame every thirty (30) seconds, or two (2) frames per minute. For each frame, seven (7) different exposures can taken by each of the cameras to provide a suitable HDR image, resulting in twenty-one (21) different exposures total for each frame from the three cameras together. The selected frame rate can be dependent on the variation in the sky image, i.e., the weather. On a clear day, with few clouds and little wind, the frame rate can be lower, i.e., fewer frames can be taken over a period of time. With a windy day and a lot of cloud formations and movement, a higher frame rate is desirable. The frame rate also is be limited by the amount of storage available and the speed of the camera. The frame rate can be set to capture the most images possible in a given time period.

Thus, as shown in FIG. 5, after initializing the cameras and controllers, the controllers perform the capture process as follows. The controller instructs the cameras to simultaneously capture 504 a first exposure of a current frame. Additional exposures are then taken 506, again simultaneously, to obtain the selected number of exposures, such as seven, per frame. If enough frames have been taken, as determined at 508, then the capture process stops. Otherwise, the controller then waits 510 until the next frame time, then repeats steps 504-508 for the next frame.

During the capture process, depending on environmental conditions, lighting, clouds, fog and the like, it may be desirable to change various settings in the camera. Such changes can be made through the control computer. In practice, such changes can occur between two and twenty times or more a day on average. In some cases, such changes can be automated; however, whether a change should be made is often a matter of human judgment.

When the capture process stops, the controllers terminate control of the cameras. Any data files that store the captured images are closed and the data files can be made available for further processing. The result of capturing is a number x of streams, corresponding to the number of cameras, with each stream having a number y of frames per unit of time, such as two frames per minute, with each frame having a number z of exposures per frame, such a seven.

Turning now to FIG. 6, an example implementation of processing captured image data to generate sky textures, and other image data, for use in animation will now be described in more detail. The captures images from the cameras are first processed 600 to remove various artifacts and errors. For example, speckles created by dust and dirt can be removed using one or more filters. Color correction can be performed. Image grain can be removed. Chromatic aberrations also can be reduced. Vignetting also can be removed. Filters for performing such artifact removal and for making such corrections are found in many image processing tools, such as the LIGHTROOM software from Adobe Systems, Inc.

For each frame, the corrected images from each camera for the frame are then combined 602 into a single HDR image for the frame. Such combination includes stitching together the images to produce one large texture. Lens distortion also can be removed. Such a combination of images can be performed with compositing software running on a computer. An example of commercially available software that can be used is the NUKE compositor, available from The Foundry, Ltd., of London, United Kingdom. Using the NUKE compositor, a single script can be written and executed by the compositor on the captured image data to generate the HDR images and perform the stitching operations to generate the texture for each frame. The sequence of sky textures resulting from combining the HDR images can be stored 604 in data files. Typically one data file stores a single per image, and other information is used to arrange the image files in time order. For example, an array of file names or other array of information or index can be used to order the image files. Alternatively, the file names may use sequential numbering representing their time order.

Compositing software also can be used to compute 606 a set of motion vectors for each HDR image representing motion between that HDR image and adjacent images in the sequence. As described in more detail below, such motion vectors can be used during animation to perform interpolation. A set of motion vectors for a frame can be stored 608 in a data file, and a collection of data files for multiple frames can be stored in a manner that associates them with the corresponding collection of image files.

As a result of such processing, the animation system can be provided an array of textures as HDR images representing the sky over time, and an array of motion vectors.

Referring now to FIG. 7, additional data also can be generated from the HDR textures for each frame. While illustrated in a particular order in the flow chart of FIG. 7, the generation of these images can be performed in any order, and on different computers. In particular, the computer system generates 700 what is called a diffuse cubemap, which is a map of information describing the ambient lighting with which the animated scene will be illuminated. This can be considered a sphere of light sources. The computer system also generates 702 a fog cubemap as a blurred representation of the sky. The fog cubemap can be blended with other sky textures to create an appearance of fog. The computer system also can generate 704 a cloud shadow map. The cloud shadow map is a black and white image, such as mask data, indicating at each frame where clouds appear in the sky. All of this data can be packaged into a format to be used by a game engine.

Turning now to FIGS. 8A and 8B, a data flow diagram of an illustrative example implementation of a game engine for a video game that includes a photorealistic animated sky will now be described. In this example, a game engine is described; it should be understood that these techniques can be used to render any animation that provides a simulation of a current time in the animation, from which sky data is processed based on sample times corresponding to the current time in the animation.

In FIG. 8A, a game engine 800 includes several components, of which ones relevant to the rendering of the sky include at least: a game logic component 802, an input processing module 820, and a rendering engine 840 and an output component 850. The game logic component 802 is responsive to user input 806 to progress through various states of the game, updating game data. The input processing module 820 processes signals from various input devices (not shown) that are responsive to user manipulation to provide the user input 806. Updated game data includes three-dimensional scene data 810 defining, in part, the visual output of the game, and an updated viewpoint 812 that defines a position and orientation within a scene for which the scene data will be rendered and other game state information 808, which includes a current time in the game. The rendering engine 840 processes scene data 810 according to the viewpoint 812 and other visual data 814 for the game to generate a rendered scene 816. This rendered scene 816 data can be combined with other visual information, audio information and the like by an output component 850, to provide output data to output devices (not shown), such as a display and speakers.

To generate a photorealistic animation of sky in such a game, the rendering engine 840 also receives, as inputs, an indication of the current in-game time of day and sky data 860, as described above, corresponding to the current in-game time of day. The in-game time of day may be generated by the game logic 802 as part of game state 808. The sky data 860 is stored in several buffers accessed by the rendering engine for at least the current game time. For example, a dynamic buffer 870 capable of streaming is used to store a stream of texture data for the sky, including at least two sky textures from sample times corresponding to the current game time. Another buffer 872 stores one or more diffuse cubemaps. A buffer 874 stores one or more fog maps. A buffer 876 stores one or more cloud maps. A buffer 878 stores one or more sets of motion vectors.

As shown in FIG. 8B, the rendering engine includes, among other things, a blender 880 having inputs to receive two of the sky textures 882, 884 from buffer 870, corresponding motion vectors 886 from buffer 878, and a current in-game time of day 862. A viewpoint 812 is processed to determine a field of view for spatially sampling the sky textures 882, 884 for the current game scene. The two textures, and their corresponding motion vectors, are those having real time-of-day sample times corresponding to the current in-game time of day. The blender blends the two textures by interpolation using the motion vectors and the time of day using conventional image blending techniques. The output of such blending is a sky texture 888, which is used as a background onto which the remaining rendering of the scene is overlaid as a foreground.

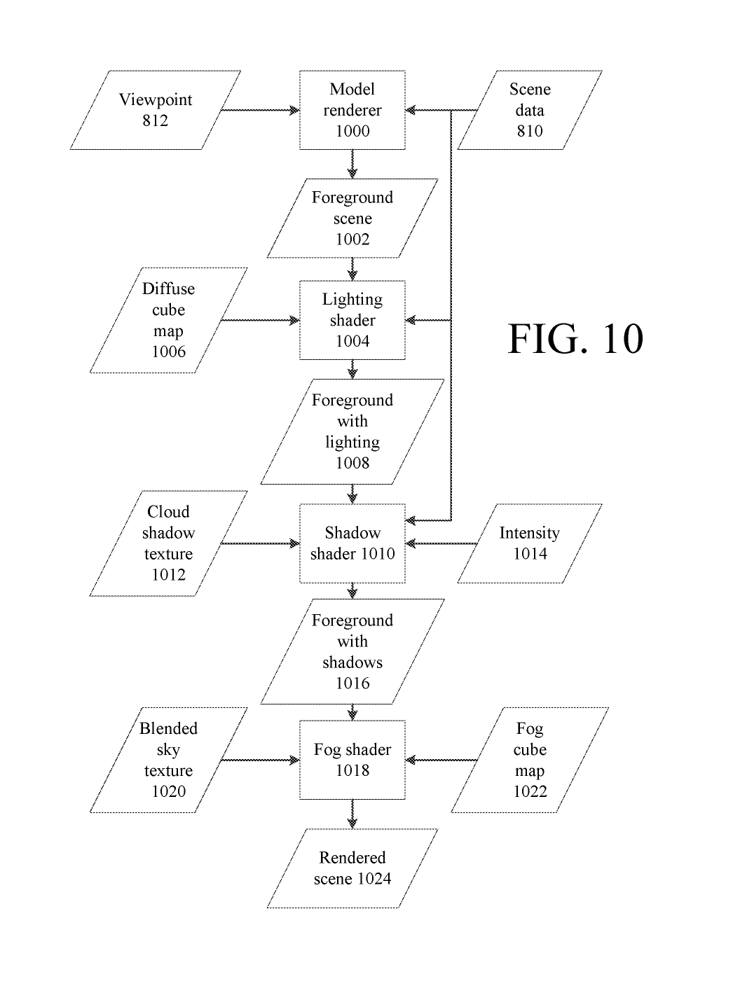

In the remaining rendering of the scene for a current in-game time of day, an example of which is described in more detail below in connection with FIG. 10, the diffuse cubemap in buffer 872, derived from images from a real time-of-day sample time corresponding to the current in-game time of day, is used as the diffuse cube map for lighting of the scene. The fog cubemap from buffer 874, derived from images from a real time-of-day sample time corresponding to the current in-game time of day, provides a fog color map for the scene that blends seamlessly towards the sky. The cloud shadow texture from buffer 872, derived from images from a real time-of-day sample time corresponding to the current in-game time of day, is overlaid on the scene as part of the shadow calculation in the light scenario, providing distant cloud shadows. This cloud shadow texture also blends towards a higher resolution generic cloud texture that scrolls in the same direction as the distant ones. At night, the cloud shadow texture is used to cut out the clouds from the main sky image, superimposing them onto a high resolution star image.

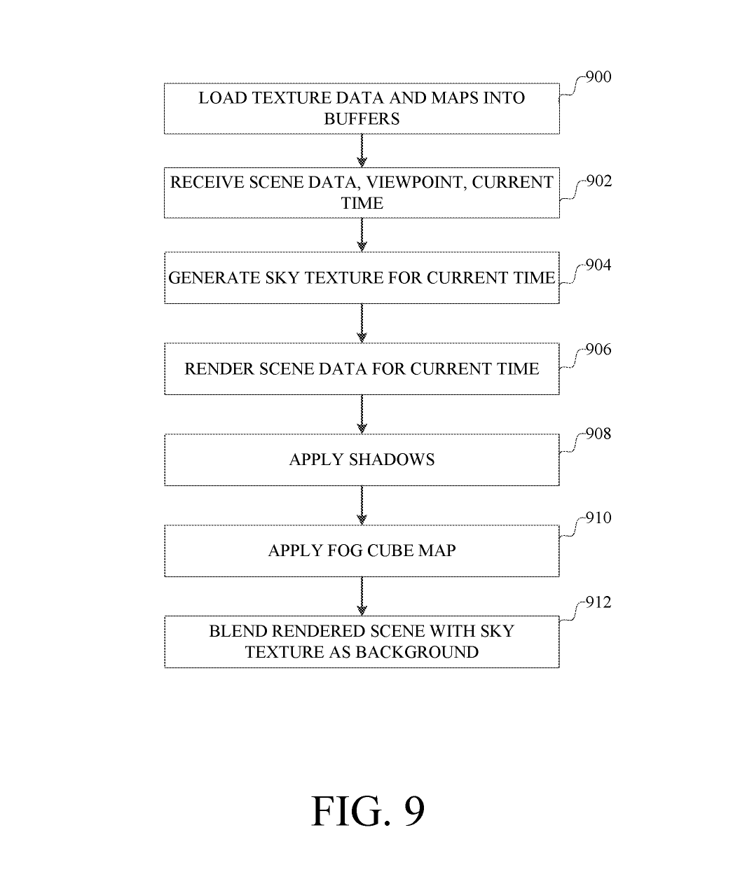

Turning now to FIG. 9, a flowchart describing the generation of a photorealistic sky in the context of a game will now be described.

Generally speaking, at any given point in time in playing time of a game, the rendering engine generates a visual representation of the state of the game, herein called the current scene. The rendering engine loads 900 into memory, such as buffers accessible by the GPU, sky textures, diffuse cube map, fob cubemap, motion vectors and the cloud shadow texture. For any given current scene, the rendering engine receives 902 scene data, a viewpoint and a current game time. The rendering engine generates 904 the sky texture for the current game time by sampling and interpolating the sky textures closest to the game time using the motion vectors. The scene data for the current game time is rendered 906, using the diffuse cube map to provide a source of lighting for the scene, in addition to any other light sources defined for the scene. Shadows are applied 908, using the cloud shadow texture, in addition to applying any other shadows defined through the scene data. A fog cube map can be applied 910 as a filter to the sky texture for the current game time, to blend a region from a horizon into the sky according to fog colors in the fog cube map. The rendered scene for the current game time is applied 912 as a foreground onto the background defined by the sky texture for the current game time.

Turning now to FIG. 10, an illustrative example of a shader tree for implementing the rendering of a scene using such techniques will now be described. The scene data 810 and viewpoint 812 (see FIG. 8) are processed by the model renderer 1000 to generate an initial representation of the foreground of the scene. This foreground is processed by a lighting shader 1004, using at least the diffuse cube map 1006 to provide apply lighting to the scene. The lighting shader may take into account of variety of other scene data 810, such as texture and reflectance information for objects in the scene. Similarly, a shadow shader 1010 applies shadows to the objects based on the cloud shadow texture 1012 and an intensity curve 1014. The intensity curve 1014 determines how strongly the cloud shadow is cast on the scene, and can be defined as a function of the current in-game time. Cloud textures also can be applied by a cloud texture shader (not shown) to the sky data before providing the final blended sky texture 1020. For example, an intensity curve (not shown) as a function of the in-game time, can use the cloud texture as a mask applied to the sky texture. The effect of clouds blocking stars at night can be produce by such masking. When the foreground 1016 is combined, as a foreground, with the blended sky texture 1010 as a background, a fog shader 1018 applies the fog cube map 1022, instead of a single fog color, to provide a smooth transition of fog between the foreground and background in the rendered scene 1024.

By accessing high dynamic range images of sky data sampled over a period of time from images of actual sky, photorealistic sky textures can be generated and applied to a scene in computer animation. From some sky data, diffuse cube maps also can be generated. Such diffuse cube maps can be used to provide lighting for the scene. The sky data also can be processed to provide fog cube maps and cloud shadow maps. By accessing cloud shadow maps, realistic shadows can be generated on the scene.

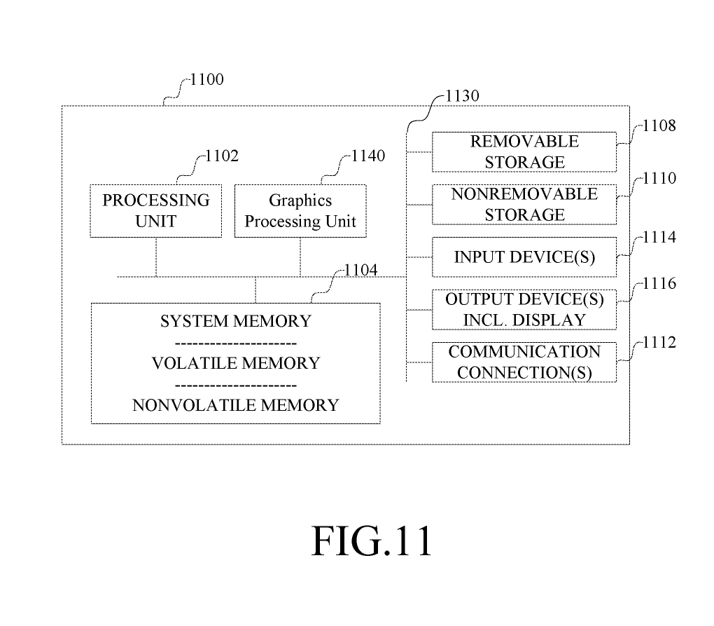

Having now described an example implementation, FIG. 11 illustrates an example of a computer with which such techniques can be implemented to provide an emulator. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), rack mounted computers, multiprocessor systems, microprocessor-based systems, programmable consumer electronics, networked personal computers, minicomputers, mainframe computers, and distributed computing environments that include any of the above types of computers or devices, and the like.

Referring now to FIG. 11, a computer generally incorporates a general purpose computer with computer programs providing instructions to be executed by one or more processors in the computer. Computer programs on a general purpose computer generally include an operating system and applications. The operating system is a computer program running on the computer that manages access to various resources of the computer by the applications and the operating system. The various resources generally include the one or more processors, storage (including memory and storage devices), communication interfaces, input devices and output devices. FIG. 11 illustrates an example of computer hardware of a computer in which an operating system, such as described herein, can be implemented using computer programs executed on this computer hardware. The computer hardware can include any of a variety of general purpose or special purpose computing hardware configurations of the type such as described in FIG. 11.

With reference to FIG. 11, an example computer 1100 includes at least one processing unit 1102 and memory 1104. The computer can have multiple processing units 1102 and multiple devices implementing the memory 1104. A processing unit 1102 can include one or more processing cores (not shown) that operate independently of each other. Additional co-processing units also can be present in the computer, including but not limited to one or more graphics processing units (GPU) 1140, one or more digital signal processing units (DSPs) or programmable gate array (PGA) or other device that can be used as a coprocessor. The memory 1104 may include volatile devices (such as dynamic random access memory (DRAM) or other random access memory device), and non-volatile devices (such as a read-only memory, flash memory, and the like) or some combination of the two. Other storage, such as dedicated memory or registers, also can be present in the one or more processors. The computer 1100 can include additional storage, such as storage devices (whether removable or non-removable) including, but not limited to, magnetically-recorded or optically-recorded disks or tape. Such additional storage is illustrated in FIG. 11 by removable storage device 1108 and non-removable storage device 1110. The various components in FIG. 11 are generally interconnected by an interconnection mechanism, such as one or more buses 1130.

A computer storage medium is any medium in which data can be stored in and retrieved from addressable physical storage locations by the computer. Computer storage media includes volatile and nonvolatile memory, and removable and non-removable storage devices. Memory 1104, removable storage 1108 and non-removable storage 1110 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 1100 may also include communications connection(s) 1112 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals. Communications connections 1112 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media. One or more processes may be running on the processor and managed by the operating system to enable data communication over such connections.

The computer 1100 may have various input device(s) 1114 such as a keyboard, mouse or other pointer or touch-based input devices, stylus, camera, microphone, sensors, such as accelerometers, thermometers, light sensors and the like, and so on. The computer may have various output device(s) 1116 such as a display, speakers, and so on. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 1110, communication connections 1112, output devices 1116 and input devices 1114 can be integrated within a housing with the rest of the computer, or can be connected through various input/output interface devices on the computer, in which case the reference numbers 1110, 1112, 1114 and 1116 can indicate either the interface for connection to a device or the device itself as the case may be.

A computer generally includes an operating system, which is a computer program running on the computer that manages access to the various resources of the computer by applications. There may be multiple applications. The various resources include the memory, storage, input devices, output devices, and communication devices as shown in FIG. 11.

The various modules in FIGS. 1 and 4-10, as well as any operating system, file system and applications on a computer implementing those module, and on a computer as in FIG. 11, can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data or configure the computer to implement various components or data structures.

Accordingly, in one aspect, a computer configured to generate computer animation in real time in response to user input comprises memory comprising a plurality of buffers and a processing unit configured to access the plurality of buffers. The processing unit is further configured by a computer program to: load the plurality of buffers with a sky texture and a diffuse cubemap, the sky texture and diffuse cubemap originating from samples of actual sky taken over a period of time; to receive scene data, a current time and a viewpoint; to render the scene data according to the viewpoint and the diffuse cubemap; to sample and interpolate the sky texture according to the current time; and to apply the rendered scene data as a foreground image to the interpolated sky texture as a background image.

In another aspect, a computer-implemented process, comprises loading a plurality of buffers with a sky texture and a diffuse cubemap, the sky texture and diffuse cubemap originating from samples of actual sky taken over a period of time;receive scene data, a current time and a viewpoint; rendering the scene data according to the viewpoint and the diffuse cubemap; sampling and interpolating the sky texture according to the current time; and applying the rendered scene data as a foreground image to the interpolated sky texture as a background image.

In one aspect, a computer includes a means for interpolating sky textures associated with a sample time using motion vectors associated with the sky textures to obtain a sky image; and means for applying the sky image as a background to animation.

In another aspect, a camera rig comprises at least three cameras affixed to a platform, each camera including a lens having a bottom field of view and a top field of view, wherein, when the platform is parallel with the horizon, the bottom fields of view of the cameras are approximately aligned with the horizon, the top fields of view are at least in part overlapping. The camera rig can include a controller configured to cause the cameras to take multiple different exposures at a frame time, and to cause the camera to take such exposures at a frame rate.

In one aspect, a camera rig comprises a plurality of cameras, means for positioning the cameras to have bottoms of fields of view approximately aligned with the horizon, the top fields of view are at least in part overlapping.

In one aspect, a computer comprises a means for receiving a plurality of simultaneous exposures from a plurality of cameras sampled at a frame rate of a plurality of images and means for generating from the images a sequence of sky textures, motion vectors and diffuse cube map.

In any of the foregoing aspects, a processing unit can be further configured to apply a fog cubemap derived from the samples of actual sky to the rendered scene data and interpolated sky texture.

In any of the foregoing aspects, a processing unit can be further configured to apply a cloud shadow map derived from the sample of actual sky to the scene data when rendering the scene data.

In any of the foregoing aspects, a processing unit can be further configured to apply the cloud shadow map to the interpolated sky texture as a mask.

In any of the foregoing aspects, the sky texture comprises a sequence of high dynamic range images, each derived from a plurality of simultaneous exposures from a plurality of cameras sampled at a frame rate of a plurality of images. The period of time, in some implementations, is at least twenty-four hours. In some implementations, the plurality of cameras comprises three cameras, each configured to capture a plurality of images for each frame at the frame rate.

In any of the foregoing aspects, a camera rig can further include a light probe positioned in the field of view of one of the cameras.

Any of the foregoing aspects can be combined with other aspects to provide yet additional aspects of the invention. For example, a camera rig can be combined with the post-processing computer. A post-processing computer can be combined with animation rendering, whether in an interactive animation engine or an authoring tool.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only. What is claimed is:

1. A computer configured to generate computer animation in real time in response to user input, the computer comprising:
memory comprising a plurality of buffers;
a processing unit configured to access the plurality of buffers;
the processing unit further configured by a computer program to:
load the plurality of buffers with a sky texture and a diffuse cubemap, wherein the diffuse cubemap comprises a map of information representing ambient lighting for illuminating a scene, the sky texture and diffuse cubemap originating from samples of actual sky taken over a period of time;
receive scene data, a current time and a viewpoint;
render the scene data according to the viewpoint and the diffuse cubemap, such that objects in the scene data are illuminated based on at least the diffuse cubemap;
sample and interpolate the sky texture according to the current time; and
apply the rendered scene data as a foreground image to the interpolated sky texture as a background image.

2. The computer of claim 1, wherein the processing unit is further configured to:
apply a fog cubemap derived from the samples of actual sky to the rendered scene data and interpolated sky texture.

3. The computer of claim 1, wherein the processing unit is further configured to:
apply a cloud shadow map derived from the sample of actual sky to the scene data when rendering the scene data.

4. The computer of claim 3, wherein the processing unit is further configured to apply the cloud shadow map to the interpolated sky texture as a mask.

5. The computer of claim 1, wherein the sky texture comprises a sequence of high dynamic range images, each derived from a plurality of simultaneous exposures from a plurality of cameras sampled at a frame rate of a plurality of images.

6. The computer of claim 5, wherein the period of time is at least twenty-four hours.

7. The computer of claim 5, wherein the plurality of cameras comprises three cameras, each configured to capture a plurality of images for each frame at the frame rate.

8. An article of manufacture, comprising:
a computer storage medium comprising at least a memory or a storage device
computer program instructions stored on the computer storage medium that, when processed by a computer, configure the computer to:
load a plurality of buffers with a sky texture and a diffuse cubemap, wherein the diffuse cubemap comprises a map of information representing ambient lighting for illuminating a scene, the sky texture and diffuse cubemap originating from samples of actual sky taken over a period of time;
receive scene data, a current time and a viewpoint;
render the scene data according to the viewpoint and the diffuse cubemap;
sample and interpolate the sky texture according to the current time; and
apply the rendered scene data as a foreground image to the interpolated sky texture as a background image.

9. The article of manufacture of claim 8, wherein the computer is further configured to apply a fog cubemap derived from the samples of actual sky to the rendered scene data and interpolated sky texture.

10. The article of manufacture of claim 8, wherein the computer is further configured to apply a cloud shadow map derived from the sample of actual sky to the scene data when rendering the scene data.

11. The article of manufacture of claim 10, wherein the computer is further configured to apply the cloud shadow map to the interpolated sky texture as a mask.

12. The article of manufacture of claim 8, wherein the computer program instructions form a game engine, wherein the game engine further configures the computer to:
receive user inputs;
in response to user inputs, continually update game state including updated scene data according to game logic; and
the game engine providing the current time associated with the game state.

13. The article of manufacture of claim 8, wherein the sky texture comprises a sequence of high dynamic range images, each derived from a plurality of simultaneous exposures from a plurality of cameras sampled at a frame rate of a plurality of images.

14. The article of manufacture of claim 13, wherein the plurality of cameras comprises three cameras, each configured to capture a plurality of images for each frame at the frame rate.

15. A computer-implemented process, comprising:
loading a plurality of buffers with a sky texture and a diffuse cubemap, wherein the diffuse cubemap comprises a map of information representing ambient lighting for illuminating a scene, the sky texture and diffuse cubemap originating from samples of actual sky taken over a period of time;
receiving scene data, a current time and a viewpoint;
rendering the scene data according to the viewpoint and the diffuse cubemap, such that objects in the scene data are illuminated based on at least the diffuse cubemap;
sampling and interpolate the sky texture according to the current time; and
applying the rendered scene data as a foreground image to the interpolated sky texture as a background image.

16. The computer-implemented process of claim 15, further comprising applying a fog cubemap derived from the samples of actual sky to the rendered scene data and interpolated sky texture.

17. The computer-implemented process of claim 15, further comprising applying a cloud shadow map derived from the sample of actual sky to the scene data when rendering the scene data.

18. The computer-implemented process of claim 17, further comprising applying the cloud shadow map to the interpolated sky texture as a mask.

19. The computer-implemented process of claim 16, wherein the sky texture comprises a sequence of high dynamic range images, each derived from a plurality of simultaneous exposures from a plurality of cameras sampled at a frame rate of a plurality of images.

20. The computer-implemented process of claim 16, wherein the period of time is at least twenty-four hours.
